(19) United States
(12) Patent Application Publication
(10) Pub. No.: US 2020/0226661 A1
(43) Pub. Date: Jul. 16, 2020

(54) ENCODING TEXTUAL DATA FOR PERSONALIZED INVENTORY MANAGEMENT

(71) Applicant: Punchh Inc., San Mateo, CA (US)

(72) Inventors: Tian Lan, Foster City, CA (US); Xin Heng, Millbrae, CA (US)

(21) Appl. No.: 16/741,594

(22) Filed: Jan. 13, 2020

Related U.S. Application Data
(60) Provisional application No. 62/792,174, filed on Jan. 14, 2019.

(51) Int. Cl. G06Q 30/06; G06Q 10/08; G06F 16/33; G06K 9/62

(52) U.S. Cl. CPC G06Q 30/0631; G06Q 30/0629; G06K 9/6269; G06F 16/3334; G06Q 10/087

(57) ABSTRACT

A system and a method are disclosed for encoding textual data for personalized recommendations using at least one encoder. An inventory catalog management system receives both the description data of inventory items and the human characteristic data from customers, and trains encoders to generate feature representations that capture degrees to which human characteristics have affinities to an inventory item. For example, the feature representation for a vegetarian customer and a chicken salad indicates a low affinity for the protein aspect of the chicken salad because the customer prefers vegetables. The system, using the generated feature representations, may partition products into categories based on the similarity measure of the products and recommend appropriate products to improve personalized recommendations.

### CROSS REFERENCE TO RELATED APPLICATIONS

This application claims the benefit of U.S. Provisional Application No. 62/792,174, filed Jan. 14, 2019, which is incorporated by reference in its entirety.

### TECHNICAL FIELD

The disclosure generally relates to textual encoding, and more particularly, to managing inventory based on output of one or more encoders.

### BACKGROUND

Text is often used to describe inventory of an enterprise. For example, “chicken salad” may be used to describe an available menu item in a restaurant. Different enterprises may use different text to describe the same inventory item. One restaurant may use “organic chicken salad” and another restaurant may use “chk sld” to refer to the chicken salads on their menus. These descriptions may vary substantially in their length or spelling. For example, the text “organic chicken salad” uses an extra descriptive of “organic” while “chk sld” uses a different spelling that lacks vowels to create a short form of the item name. A technical problem arises when different descriptions or, as interpreted by a computer, textual data from enterprises, due to non-standardized forms that are inconsistent, redundant, and/or highly variable, cannot be aggregated for personalized inventory management (e.g., when determining personalized recommendations).

### SUMMARY

Described herein are embodiments of systems and methods for encoding textual data for personalized inventory management. An inventory catalog management system described herein may encode varying inventory descriptions for similar inventory items into respective, unique representations that are similar to one another. This representation may, in turn, be used to manage a personalized inventory (e.g., to determine personalized recommendations that are more consistent and accurate).

For example, the inventory catalog management system may receive product inventory data from a database maintained by an enterprise (e.g., a retail business). For example, the inventory catalog management system receives textual data or “descriptive textual data” describing the name of a menu item (e.g., “chicken sld” referring to a chicken salad). An encoder may receive the textual data and output a distributed representation of the textual data. For example, the encoder outputs a vector of item scores, where each item score of the vector represents a degree to which the textual data corresponds to inventory item or description of an inventory item (e.g., a −0.31 degree that “chicken sld” corresponds to a “drink” item and a 0.75 degree that “chicken sld” corresponds to a “protein” item). Another encoder may generate, using the vector of item scores, a vector of human characteristic scores for each value in the vector of item scores. In some embodiments, each human characteristic score of the vector of human characteristic scores represents a degree to which the item score corresponds to a human characteristic. For example, the 0.75 degree that “chicken sld” corresponds to a “protein” item is used to produce a vector of human characteristic scores for characteristics such as “vegetarian” or “spend amount.” A −0.83 degree may be output as a human characteristic score for “vegetarian” while a 0.79 degree may be output as a human characteristic score for “spend amount” (e.g., customers who spend more money are correlated to those who purchase proteins). A 2-dimensional (2D) feature representation is generated by the inventory catalog management system that may be a concatenated representation of each vector of human characteristic scores. The inventory catalog management system may use the feature representation to manage a personalized inventory (e.g., output a recommendation).

In some embodiments, the inventory catalog management system analyzes the product information it has encoded and concatenated together to determine personalized product recommendations. For example, the inventory catalog management system identifies the distributed representations of the product description data, partitions products into a plurality of inventory categories based on the similarity measure of the products, recommends appropriate products for upsell and cross-sell, and personalizes the products in the inventory for individual customer. For example, the inventory catalog management system determines, using the generated feature representation in the example above, that “chicken sld” corresponds to a chicken salad, which is commonly purchased with potato chips. The inventory catalog management system may publish a recommendation to purchase potato chips for a user on his client device. In another example, the inventory catalog management system may determine, using the feature representation, that “chicken sld” corresponds to a chicken salad, which has a similar feature representation to that of a cobb salad. The inventory catalog management system may publish a recommendation to purchase a cobb salad as a similar menu item to the chicken salad. In this way, the inventory catalog management system standardizes crowdsourced inventory catalog data and generates feature representations using customer data to generate tailored recommendations for retail customers through various sales channels.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 is a network diagram illustrating a communication environment in which an inventory catalog management system operates, in accordance with at least one embodiment.

Figures (FIGS. 2A and 2B are block diagrams of the inventory catalog management system of FIG. 1, in accordance with at least one embodiment.

FIGS. 3A and 3B depict graphical user interfaces (GUIs) for receiving product recommendations determined by the inventory catalog management system of FIG. 1, in accordance with at least on embodiment.

FIG. 4 shows a diagrammatic representation of a computer system for implementing the inventory catalog management system of FIG. 1, in accordance with at least one embodiment.

FIG. 5 is a flowchart illustrating a process for outputting a recommendation using the inventory catalog management system of FIG. 1, in accordance with at least one embodiment.

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Exemplary Inventory Catalog Management System Architecture

FIG. 1 is a network diagram illustrating communication environment 100 in which inventory catalog management system 140 operates. Communication environment 100 includes network 110, enterprises 120 and 130, one or more client devices 150, and inventory catalog management system 140. In alternative configurations, different and/or additional components may be included in communication environment 100.

Network 110 is communicatively coupled with at least one enterprise (e.g., enterprise 120 and enterprise 130), at least one client device (e.g., client devices 150), and an inventory catalog management system 140. In some embodiments, network 110 may be communicatively coupled between only at least one enterprise and inventory catalog management system 140. For example, network 110 communicatively couples enterprise 120 with inventory catalog management system 140 only. In some embodiments, network 110 may be communicatively coupled between only at least one client device and inventory catalog management system 140 (e.g., between client devices 150 and inventory catalog management system 140). Network 110 may be one or more networks including the Internet, a cable network, a mobile phone network, a fiberoptic network, or any suitable type of communications network.

Enterprises 120 and 130 may be any enterprise including a retail business, department store, super market, Internet retailer, small business, restaurant, or any suitable enterprise associated with (e.g., selling, aggregating, monitoring, etc.) an inventory of products and/or services. The terms “product” and “item,” as used herein, refer to inventory of products and/or services sold by an enterprise to a customer. Enterprises 120 and 130 may implement a local database of inventory (e.g., source databases 121 and 131, respectively). In some embodiments, source databases 121 and 131 include a list of inventory items (e.g., a list of groceries for sale at a super market or a list of menu items at a restaurant). Enterprise 120 may include an electronic device 122 that communicates with network 110 and stores source database 121.

Client devices 150 include mobile phones, laptop computers, tablet computers, personal computers, smart television, or any suitable computing device capable of communicating with a network (e.g., network 110). Each client device may be associated with a respective user or user profile. The user profile associated with a client device may be configurable or accessible by inventory catalog management system 140 and/or enterprises 120 or 130.

Inventory catalog management system 140 may receive data from enterprises 120 and 130 and client devices 150 through network 110. In some embodiments, inventory catalog management system 140 organizes and standardizes the received data to then determine recommendations for enterprises 120 and 130 and/or client devices 150. Inventory catalog management system 140 stores and maintains at least one database for inventory data, customer data, vector representations of data (e.g., vector representations of inventory, customers, and hybridized representations of both inventory and customers), and software modules that perform various operations such as encoding data into vector representations, optimizing the vector representations, determining similarity between inventory items based on optimized vector representations, and recommending products based on determined similarities. Inventory catalog management system 140 is further described in the description of FIGS. 2A-2B.

### Inventory Catalog Management System

FIGS. 2A and 2B are block diagrams of the inventory catalog management system of FIG. 1. Inventory catalog management system 140, as shown in FIG. 2A, includes multiple software modules: representation generator 200, similarity measurer 210, product information organizer 220, product catalog classifier 230, product similarity ranker 240, and product affinity recommender 250. In some embodiments, inventory catalog management system 140 includes additional, fewer, or different components for various functions.

Representation generator 200 generates combined, mathematical representations of product description data and human characteristic data. The product description data may be referred to herein as “textual data” or “descriptive textual data.” In some embodiments, representation generator 200 receives product description and customer data (e.g., transactions) from databases (e.g., source databases 121 and/or 131 of enterprises or system-managed databases that may be stored locally or on an external server). Representation generator 200 may, as shown in FIG. 2B, include additional software submodules: text encoder 201, affinity encoder 202, and optimizer 203. Representation generator 200 may output its generated representations to similarity measurer 210, product information organizer 220, product catalog classifier 230, product similarity ranker 240, and/or product affinity recommender 250.

Text encoder 201 generates a mathematical representation of product description data. For example, text encoder 201 receives product description data and generates a vector of real numbers representing multiple features of a product. The vector is referred to herein as a “item score vector.” To produce the item score vector, text encoder 201 may execute a distributed representation process that analyzes text documents and sentences of the documents. Each product description may be regarded as a sentence of a document or the document itself in the distributed representation process. Text encoder 201 maps the sentence or document to a unique vector and maps each word in the sentence or document to another unique vector.

One or more matrices may be initialized. In an embodiment, two matrices may be initialized: a word matrix and a document matrix. In some embodiments, the encoded representation of all inventory items is aggregated in a document matrix and the encoded representation of words used in item descriptions are aggregated in a word matrix. Text encoder 201 may initialize the matrices using substantially random values (e.g., using a random number generator). Each column or row of the word matrix may map to a word vector of the product description. For example, “chicken” and “salad” are two words that obtained from the product description “chicken salad.” The word vectors for “chicken” and “salad” may be denoted as w₁ and w₂, respectively, and are contained in the word matrix, w, of Equation 1 below. Word vectors may be positioned in the vector space such that words that share common contexts in the corpus are located in close proximity to one another (e.g., represented by a cosine similarity of the vectors). In some embodiments, each column or row of the document matrix maps to the entire product description. For example, “chicken salad,” denoted as D₁, forms a document vector and “chk salad,” denoted as D₂, forms another document vector in document matrix D in Equation 1. Text encoder 201 may be trained using a softmax classifier of a fixed window size of k, which scans the product description to minimize the log likelihood in Equation 1.

$$\begin{matrix}Product Description Log Likelihood & \\ \frac{1}{M} {\sum }_{i = 1}^{M} 1 / \vert {D}_{i} \vert {\sum }_{t = k}^{\vert {D}_{i - 1} \vert - k} log ( p ( {w}_{t}^{i} \vert {w}_{t - k}^{i} , … , {w}_{t + k}^{i} , {D}_{i} ) ) & Equation 1\end{matrix}$$

where Dᵢ corresponds to the vector representing the i^{th} document, |Dᵢ| is the number of words in the i^{th} document, and wₜⁱ is the t^{th} word in the i^{th} document. The training optimization remembers the document that the softmax classifier is scanning and updates the row in the matrix D along with the words in that window. In text encoder 201, the document matrix D acts as the final output that encodes the contents of the product description as an entire document or sentence and the relationship of each word in the sentence. As referred to herein for text encoder 201, documents and sentences include a logical arrangement of words. Using Equation 1, text encoder 201 may create document vector Dᵢ and word vectors wₜⁱ simultaneously. While a document vector may include the concatenation of word vectors, a document vector alone is a unique representation. For example, matrix [w₁ w₂ D₁] may be a document vector while D₁ itself is a unique representation of a product description.

As a non-limiting example, text encoder 201 generates an item score vector [0.39, 0.75, −0.31, 0.13, 0.03]. This example vector with a size of 5 scores is relatively small and is adopted to facilitate understanding in the present application. Text encoder 201 may generate very large vectors that may only be practically interpreted by a computer (e.g., calling upon a decoder). In some embodiments, each score in the vector corresponds to a weight for an item category. Text encoder 201 may learn item categories from text descriptions of product items in an unsupervised and task-agnostic manner. For example, each score corresponds respectively to weights for item categories “vegetable,” “protein,” “drink,” “fruit,” and “grain.” A relatively large score or weight is given to the descriptor “protein” because chicken salad has chicken in it. A smaller weight may be given to “vegetable” because text encoder 201 determines that “chicken” carries more significance in the description “chicken salad” than “salad.” A much smaller score is given to the descriptor “drink” because a chicken salad is not a drink (e.g., a negative indicates that a lack of a descriptor while the magnitude indicates the degree to which the item lacks the descriptor). In some embodiments, the output of text encoder 201 is referred to as a dense document vector output for a product description (e.g., “chicken salad”).

The vectors of individual words in the product descriptions of a product and the vectors of sentences of the product descriptions of the product are used simultaneously to train text encoder 201 to generate item score vectors. For example, text encoder 201 is trained with both words and sentences of product descriptions referring to the same product using stochastic gradient descent. The training may minimize the likelihood that a false prediction of the next word in the product description occurs. While the same word vectors may be used by text encoder 201 to predict the next word in product descriptions of all inventory items, the vector generated by text encoder 201 for a product is nonetheless unique to that product. For example, a word vector for “chicken” is used for both “chicken salad” and “chicken enchilada” while the generated vector (e.g., item score vectors) for “chicken salad” is different from the generated vector for “chicken enchilada.” Using these unique vectors, inventory management system 140 may identify product similarities based on essential product information with minimal effect from missing, incomplete, or noisy product descriptions contained in crowdsourced catalog data.

Text encoder 201 may predict, based on the analysis of product descriptions into generated document and word vectors, words in a product description. Text encoder 201, as described above, maps product description (e.g., a “sentence”) to a unique vector, represented by a column in a matrix D of Equation 1, and each word in the sentence is also mapped to a unique vector, represented by a column in matrix w of Equation 1. Text encoder 201 may average and/or concatenate the generated word and sentence vectors to predict the next word in the context of the sentence (e.g., in the context of the product description). For example, in the context of the sentence “fried chk,” text encoder 201's generated word vectors for “fried” and “chk” may correspond to vectors for “fried” and “chicken”—as opposed to “fried” and “chickpeas”—because the likelihood that “chicken” comes after “fried” is high.

By predicting words that a highly-variable product description received from an enterprise is referring to, text encoder 201 produces distributed representations of product descriptions of arbitrary length. For example, enterprise 120 may use textual data “chicken sld” to represent a chicken salad in source database 121 and enterprise 130 may use textual data “chk sld” to represent a chicken salad in source database 131. The textual data obtained through crowdsourcing may be a short form name (e.g., “chk sld”) or include misspellings (e.g., “chiken salad”) or extra text (e.g., “organic chicken salad”). Inventory catalog management system 140 handles the complexity and noise caused by the multiple, alternative names for the same product, determining that the various names refer to the same product (e.g., “chicken salad”).

It may be noted that this dense vector and other vector representations generated by encoders, while containing encoded features representing product essential information, may not be directly interpretable (e.g., by a human being) without a corresponding decoding process. Text encoder 201 may execute a continuous and dense categorization approach rather than human-understandable categorization strategies because the latter may be inefficient due to being discrete and sparse.

Affinity encoder 202 generates a combined, mathematical representation of product description data and human characteristic data. In some embodiments, affinity encoder 202 receives product description data from enterprises (e.g. enterprises 120 and 130) and human characteristic data from those enterprises or from users (e.g., customers) through client devices (e.g., client devices 150) and/or one or more databases in communication environment 100 that maintains profile information for enterprises and/or users. For example, human characteristic data from restaurants includes an aggregate of customer ages, favorite menu items, purchasing times, purchasing frequencies, dietary restrictions, any suitable data generated based on a human's purchasing of an inventory item or human's intention to purchase an inventory item, or any suitable combination thereof. In some embodiments, human characteristic data includes customer transaction data and customer profile data. For example, customer transaction data indicates customers purchase chicken salad with potato chips. Customer profile data of human characteristic data may indicate that customers prefer vegetarian products. Customer transaction and profile data may represent an aggregate of customers. For example, customer transaction data indicates that 55% of a restaurant's customers purchases chicken salad with potato chips. Human characteristic data input to affinity encoder 202 augments the item score vector generated by text encoder 201 such that affinity encoder 202 generates a mathematical representation with an additional dimension of data, where the data represents the affinity between a human characteristic of the received human characteristic data and an item category of the item score vector. This generated mathematical representation, which may be a 2D matrix of real numbers, is referred to herein as a “feature representation.” Each value of the feature representation may be indicative of a combination of product description data and human characteristic data.

In some embodiments, affinity encoder 202 uses the item categories of the item score vector as a first dimension and human characteristics as a second dimension. By using the vector of item scores from text encoder 201 to organize the second dimension of human characteristics, affinity encoder 202 may group products with similar attributes together and reduce the sparsity of item and customer-product interactions. For example, while existing inventory management systems may indicate that a vegetarian has ordered five menu items from a restaurant, and the inventory catalog management system described herein may indicate that a vegetarian is likely to order those five menu items, an additional three other vegetarian menu items, and unlikely to order the other thirty menu items remaining. Affinity encoder 202 builds a second dimension representing the interactions between the customers and products by expanding each entry of the item score vector with a second vector that is normal to the dimension of the item score vector. In this second dimension, values of the second vector may quantify the score or weight of each human characteristic. For example, the affinity of a human characteristic (e.g., “vegetarian”) to an item category (e.g., “vegetable”) is quantified. A non-limiting example of a feature representation generated by affinity encoder 202 is shown below using the item score vector for “chicken salad,” [0.39, 0.75, −0.31, 0.13, 0.03].

$$\begin{matrix}is\_female \\ is\_vegetarian \\ elder \\ visit\_times \\ spent\_amount\end{matrix} [ \begin{matrix}0.58 & 0.47 & … & … & … \\ 0.89 & - 0.83 & … & … & … \\ 0.67 & 0.42 & … & … & … \\ 0.72 & 0.69 & … & … & … \\ 0.83 & 0.79 & … & … & …\end{matrix} ]$$

Recall the first value of the example item score vector corresponds to an item category of “vegetable” and the second value corresponds to an item category of “protein.” Affinity encoder 202 has generated the affinity quantities for those two item categories for human characteristic “is_vegetarian” of 0.89 and −0.83, respectively. The quantities indicate that a vegetarian has a higher affinity to vegetables than to proteins.

In some embodiments, affinity encoder 202 also encodes customer profiles (e.g., a single profile or an aggregate of many profiles) into a mathematical representation. Customer profile data that is encoded by affinity encoder 202 includes customer age and location. Customer profile data may be an aggregate of customers at one or more enterprises. For example, customer profile data may indicate that 2% of a restaurant's customers are vegetarian. In some embodiments, affinity encoder 202 uses a one-hot identity feature to emphasize a particular human characteristic described in the customer profiles above others. For example, affinity encoder 202 may determine that “is vegetarian” is the most prominent feature of customers and de-prioritize (e.g., ignore, or apply less weight to) other human characteristics when generating a feature representation to focus on this characteristic. The generated feature representation may result in product recommendations that are highly focused on the vegetarian characteristic.

Optimizer 203 improves the accuracy of feature representations generated by affinity encoder 202 in quantifying a customer affinity to aspects of a product by minimizing the mean square error between generated mathematical representations of the product and the customer. In some embodiments, optimizer 203 generates mathematical representations of an inventory item and a customer: an inventory representation and a customer representation. These representations may be stored in a remote server or in the local server by inventory catalog management system 140.

The inventory representation may be a linear combination of an item score vector generated by text encoder 201 and the feature representation generated by affinity encoder 202. Equation 2 shows a non-limiting example of a linear combination to determine the inventory representation, p.

$${p}_{i} = {\sum }_{j} {F}^{j} {e}_{i}^{j}$$

where eᵢ^{j} is the j^{th} element of eᵢ, the item score vector for product i generated by text encoder 201, F^{j} is the feature representation generated by affinity encoder 202 corresponding to the j^{th} element of the item score vector, and pᵢ is the inventory representation for product i. Vector eᵢ may serve as the first dimension of the feature representation by encoder 202 and F^{j} may be the second dimension of the feature representation. The linear combination of products from text encoder 201 and affinity encoder 202—encoders that are orthogonal to each other in the vector representation space—may fully capture both the product description and human characteristics by incorporating features generated by both encoders. For example, the inventory representation incorporates product description features with crowdsourced transaction history, loyalty program activities, and customer profiles accounted for by affinity encoder 202.

The customer representation may be a linear combination of human characteristics

qᵤ=cᵤ+KᵤIᵤ

where cᵤ is a vector representative of human characteristics for customer u, Kᵤ is the one-hot identity feature for customer u, such as “is_vegetarian,” Iᵤ is the item score vector generated by affinity encoder 202 corresponding to Kᵤ, and qᵤ is the customer representation for customer u. In some embodiments, Kᵤ is generated by affinity encoder 202 to emphasize a human characteristic such as being vegetarian.

In some embodiments, optimizer 203 executes an optimization process to improve the feature, inventory, and customer representations. To execute this process, optimizer 203 may establish an optimization target such that if a selection of customers have affinity towards two different products (e.g., have indicated interest through a “Favorites” feature or have repeatedly purchased the two products), the inventory representations of the two products are similar as well. Likewise, optimizer 203 may establish an optimization target such that if a selection of products is purchased by the same two customers, the customer representations of the two customers are similar. Optimizer 203 may simultaneously use two training processes through gradient descent optimization algorithms. For example, optimizer 203 calculates the dot product of the inventory representation with the customer representation, ƒ (pᵢ*qᵤ+bᵢᵤ), to quantify an affinity score for customer u on product i, where ƒ is a normalization function such as an identity function or sigmoid function whereas bᵢᵤ is a bias term. The optimization target may be used by optimizer 203 to minimize the mean square error through gradient descent between the predicted affinity scores, ƒ (pᵢ*qᵤ+bᵢᵤ), and the corresponding affinities from observation (e.g., empirical affinity scores or observed affinity scores). In some embodiments, empirical affinity scores are quantified by normalizing product order frequency data.

Text encoder 201 may update the at least one of the inventory representation or customer representation based on the calculated affinity scores and error minimization. For example, text encoder 201 may increase or decrease the size of the item score vector it generates when it is being trained such that the inventory and customer representations generated by optimizer 203 are updated.

Similarity measurer 210 allows inventory catalog management system 140 to identify that different descriptions refer to the same product, partition products into multiple inventory categories, and rank similar products for upselling and cross-selling. In some embodiments, similarity measurer 210 calculates similarity between two products. For example, enterprise 120 uses “chicken salad” to describe its chicken salad menu item while enterprise 130 uses “chk salad” to describe its chicken salad menu item. Inventory catalog management system 140 may receive both entries as textual data and similarity measurer 210 may calculate the cosine similarity between two non-zero feature representations. In a non-limiting example, the cosine similarity of a “chicken salad” feature representation and “chk salad” feature representation, provided below, may be 91.2%.
chicken salad→[−0.07809586, 0.30232456, 0.0098113, −0.21609002, 0.21431842, −0.13795067, −0.15001951, −0.13045959, −0.11157355, 0.00677461]
chk salad→[0.00355626, 0.14281058, −0.06343457, −0.18492039, 0.16290061, −0.16811559, −0.14531745, −0.1090335, −0.15144643, −0.04363851]
   The cosine similarity is a measure of similarity between two non-zero vectors of an inner product space based on the cosine of the angle between them. Two vectors with the same orientation have a cosine similarity of 1, and two vectors diametrically opposed have a similarity of −1. While a similarity calculation is shown for feature representations, similarity measurer 210 may also determine similarity (e.g., using cosine similarities) of document vectors. For example, a document vector for “organic chicken salad” is different from the document vector for “chk sld” because document vectors are unique, but similarity measurer 210 may determine a large degree of similarity because the vectors both represent chicken salad.

Vectors generated by text encoder 201 and representations optimized by optimizer 203 may be used for downstream tasks (e.g., product recommendations and ranking products by similarity) performed by product information organizer 220, product catalog classifier 230, product similarity ranker 240, and product affinity recommender 250.

Product information organizer 220 determines more accurate and consistent product information that minimizes the noise and sparsity inherent in crowdsourced data (e.g., short forms and misspellings in product descriptions). For example, production information organizer 220 determines that “chicken salad” and “chk salad” are referring to the same product because their inventory representations are similar (e.g., determined by similarity measurer 210).

Product catalog classifier 230 categorizes products using supervised and/or unsupervised machine learning methods. For a supervised method, product catalog classifier 230 receives a list of predefined categories (e.g., list of text descriptions). Product catalog classifier 230 may input the list of predefined categories into encoders 201 and 202 to generate feature representations of the categories. The encoding for categories, in some embodiments, is different from encoding for products in that the encoding for categories may be an inference process while the encoding for products may be a training process. For example, after inventory catalog management system 140 has optimized inventory representations using optimizer 230, the internal parameters of encoders 201 and 202 may be determined and fixed for both known and unknown product descriptions, including category names. In some embodiments, product catalog classifier 230 categorizes a product into its category by comparing the inventory representation of the product to feature representations of the categories (e.g., using similarity measurer 210 and/or cosine similarities). For example, inventory catalog management system 140 receives “salad” as a category and product catalog classifier 230 generates a feature representation for “salad.” Product catalog classifier 230 may list products that are most similar to the category “salad” by using similarity measurer 210. With a similarity threshold, product catalog classifier 230 may determine similar products from an inventory (e.g., an inventory recorded in source database 121) that meet the threshold requirement.

In some embodiments, product catalog classifier 230 categorizes products using an unsupervised machine learning method. In some embodiments, product catalog classifier 230 a predefined list of categories is not required for using an unsupervised method. Instead, product catalog classifier 230 may create implicit categories automatically. For example, by evaluating the inventory representations for all products in an inventory with similarity measurer 210, product catalog classifier 230 uses unsupervised clustering algorithms such as K-means, Gaussian Mixture Model (GMM) or mean-shift clustering to group products into categories.

Product similarity ranker 240 evaluates how similar a product is to a target product and ranks multiple products based on respective evaluations. In some embodiments, product similarity ranker 240 compares the inventory representations for all products in the inventory generated by affinity encoder 202 with a target product. For example, product similarity ranker 240 uses similarities calculated by similarity measurer 210. An example similarity ranking is depicted below in Table 1.

TABLE 1
Output of Product Similarity Ranker

| Rank | Item Name | Similarity |
|---|---|---|
| 1 | “tuesday spec pork taco” | 0.966 |
| 2 | “tuesday spec chicken taco” | 0.875 |
| 3 | “student spec beef taco” | 0.801 |
| 4 | “beef salad” | 0.439 |

Table 1 depicts product descriptions such as “tuesday spec pork taco” and a corresponding evaluation of similarity based on feature representations, generated by affinity encoder 202. Product similarity ranker 240 may list a predetermined number of products that are most similar to a target product. For example, a target product of “pork taco” is used to determine and rank products by their similarity. In the example of Table 1, other types of tacos such as pork, beef, and chicken were deemed to be similar. Beef salad, while understood to be a product that is as similar to a pork taco as other tacos, may be the fourth most similar product in an enterprise's inventory. In some embodiments, product similarity ranker 240 may rank products that have a similarity value within a range (e.g., from 50-100% similarity) of the target similarity value (e.g., 100%). For example, ranking products having at least 50% similarity would disqualify “beef salad” from the ranking depicted in Table 1. Inventory catalog management system 140 may cause the ranks determined by product similarity ranker 240 to be displayed at a device at an enterprise (e.g., electronic device 122 of enterprise 120). Using these ranks, enterprise 120 may improve product recommendations (e.g., for cross-selling or upselling). In some embodiments, product similarity ranker 240 and product catalog classifier 230 perform similar functions in that both use similarities calculated by similarity measurer 210 to list items that are similar to one another.

Product affinity recommender 250 calculates affinity scores for pairs of customers and products in an inventory (i.e., a customer-product pair). In some embodiments, product affinity recommender 250 calculates multiple affinity scores for a single product, each affinity score indicative of a customer's relationship with the single product (e.g., a degree at which they would likely purchase the product). An affinity score may be calculated using a dot product of inventory representation with a customer representation. By calculating a quantitative measure of affinity, product affinity recommender 250 allows inventory catalog management system 140 to provide a personalized retail experience (e.g., product upselling or recommendations) with increased accuracy, automation, and efficiency. In some embodiments, product affinity recommender 250 recommends a combination of products by determining that the corresponding affinity scores are within a range of one another. For example, the affinity scores of “chicken salad” and “potato chips” to a certain customer is within 10% of a target affinity score. In some embodiments, product affinity recommender 250 allows transfer learning to occur. For example, customers may explore items they had not explicitly sought out that have similar features or key words in their production descriptions to what they query, but have different item names or descriptions.

### Exemplary Product Recommendation User Interfaces

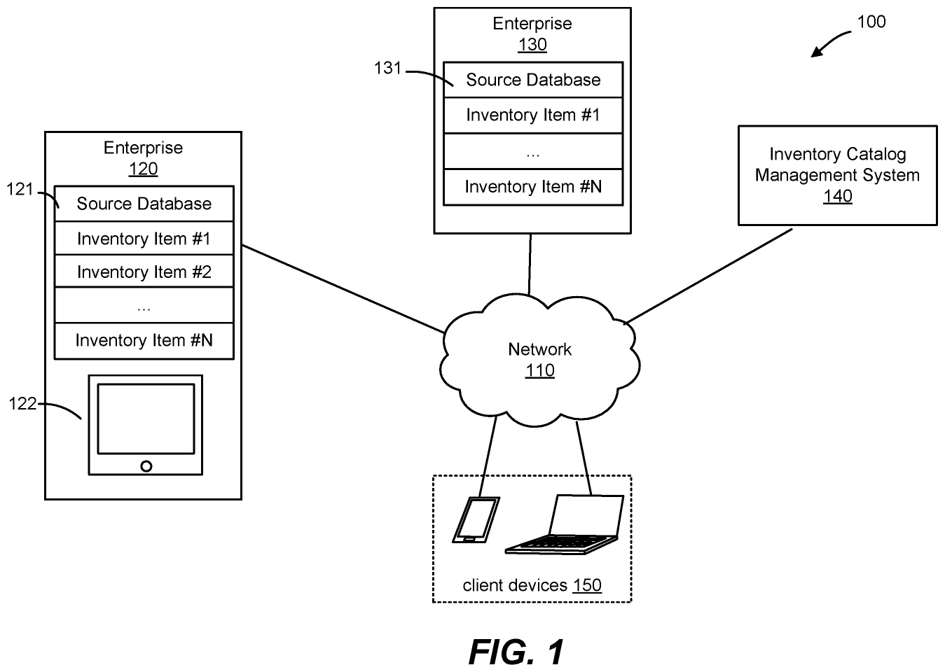

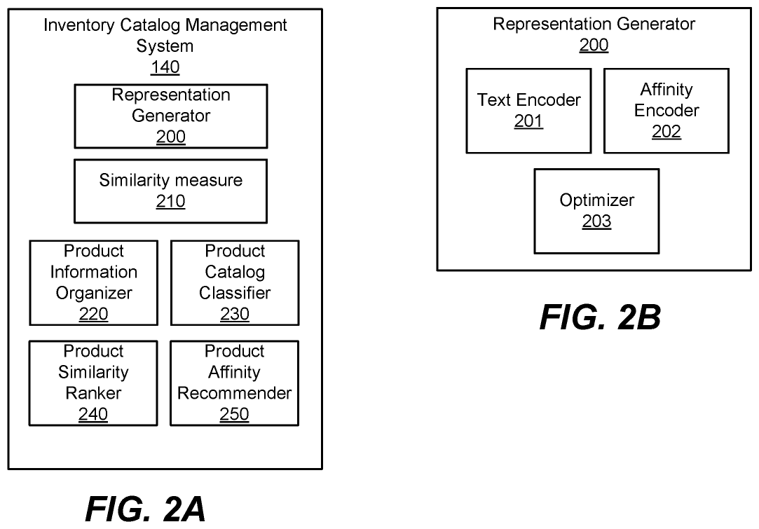

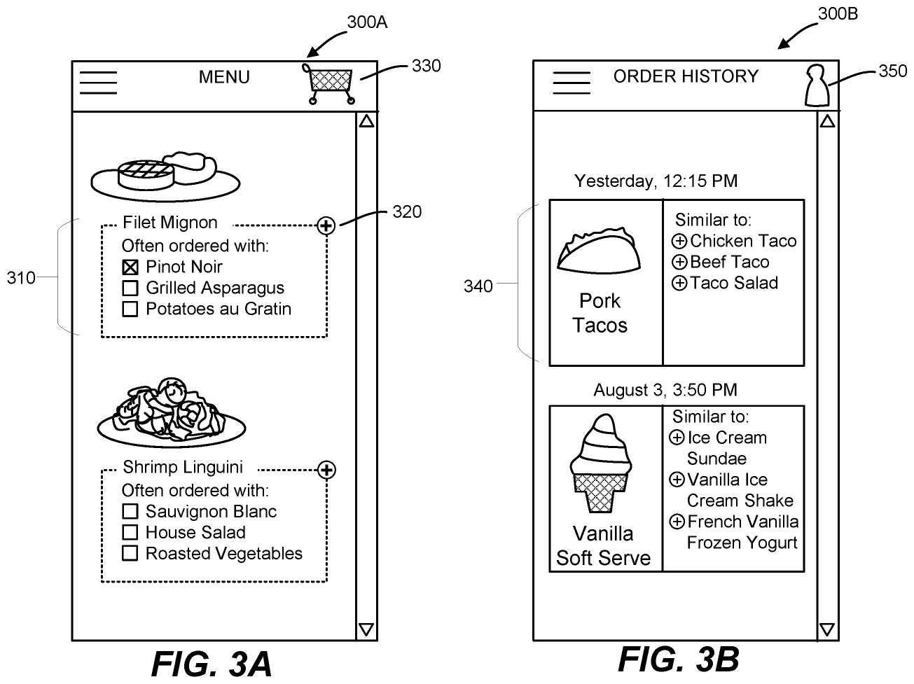

FIGS. 3A and 3B depict graphical user interfaces (GUIs) for receiving product recommendations determined by inventory catalog management system 140 of FIG. 1. GUI 300A of FIG. 3A shows a menu for customers to purchase food items through their client devices (e.g., a smartphone of client devices 150). GUI 300B of FIG. 3B shows a history of customer orders on a display of a client device (e.g., the smartphone of client devices 150).

GUI 300A includes a menu item, “Filet Mignon,” with recommendations 310, an “Add to Order” icon 320, and an order summary icon 330. In some embodiments, enterprise 120 is a restaurant with items in source database 121 being menu items (e.g., “Filet Mignon” and “Shrimp Linguine”). Inventory catalog management system 140 may communicate with enterprise 120 and the client device displaying GUI 300A to cause recommended menu items to be displayed. In some embodiments, inventory catalog management system 140 generates feature representations for menu items in source database 121 based on product descriptions and customer data crowdsourced from enterprises (e.g., enterprises 120 and 130). For example, text encoder 201 generates an item score vector for filet mignon based on item categories such as “protein,” “vegetable,” and “entrée.” Affinity encoder 202 may use the generated item score vector to generate a 2D feature representation for filet mignon that accounts for human characteristic categories such as “is_vegetarian,” “elder,” and “spent_amount.” For example, the filet mignon feature representation includes values quantifying a customer affinity for filet mignon when the customer is an elderly person who usually spends relatively large amounts of money on orders. Inventory catalog management system 140 may determine that the feature representation for filet mignon for an aggregate of customers is similar to the feature representation for pinot noir, grilled asparagus, and potatoes au gratin. The similarity calculated by similarity measurer 210 to make this determination in product similarity ranker 240 and/or product affinity recommender 250 may indicate that customers who spend a large amount of money on orders are likely to order pinot noir, grilled asparagus, and/or potatoes au gratin with their filet mignon. Inventory catalog management system 140 may minimize the error in this likelihood through optimizer 203. In some embodiments, optimizer 203 may minimize a mean square error between predicted affinity scores and empirical affinity scores for filet mignon orders (e.g., using gradient descent). A customer may select an icon to order pinot noir, depicted in GUI 300A through an “X” in a checkbox next to “Pinot Noir,” select icon 320 to add the menu items of filet mignon and pinot noir to his purchase, and finalize the order using order summary icon 330.

GUI 300B includes a menu item previously ordered, “Pork Tacos,” with similar menu items 340, and a customer profile icon 350. In some embodiments, enterprise 120 is a restaurant with items in source database 121 being menu items (e.g., “Pork Tacos” and “Vanilla Soft Serve”). Inventory catalog management system 140 may communicate with enterprise 120 and the client device displaying GUI 300B to cause similar menu items to be displayed. In some embodiments, inventory catalog management system 140 generates feature representations for menu items in source database 121 based on product descriptions and customer data crowdsourced from enterprises (e.g., enterprises 120 and 130). For example, text encoder 201 generates an item score vector for pork tacos based on item categories such as “protein,” “vegetable,” and “entrée.” Affinity encoder 202 may use the generated item score vector to generate a 2D feature representation for pork tacos that accounts for human characteristic categories such as “visit_times,” “elder,” and “is_loyalty_member.” For example, the pork tacos feature representation includes values quantifying a customer affinity for pork tacos when the aggregate of customers include the elderly, loyalty program members, and those who frequently visit or purchase from the restaurant. Inventory catalog management system 140 may determine that the feature representation for pork tacos is in a category that includes chicken tacos, beef tacos, and taco salads (e.g., a “taco” category). The similarity calculated by similarity measurer 210 to make this determination in product catalog classifier 230 may indicate that pork tacos are likely to be similar to chicken tacos, beef tacos, and taco salads. A customer may select an icon to order beef taco, depicted in GUI 300B next to the previous order of “Pork Tacos.” To access his customer profile data, the user of the client device displaying GUI 300B may select customer profile icon 350. For example, the customer profile accessible through icon 350 shows menu item favorites, personal data (e.g., age and location), and a history of orders.

### Computing Machine Architecture

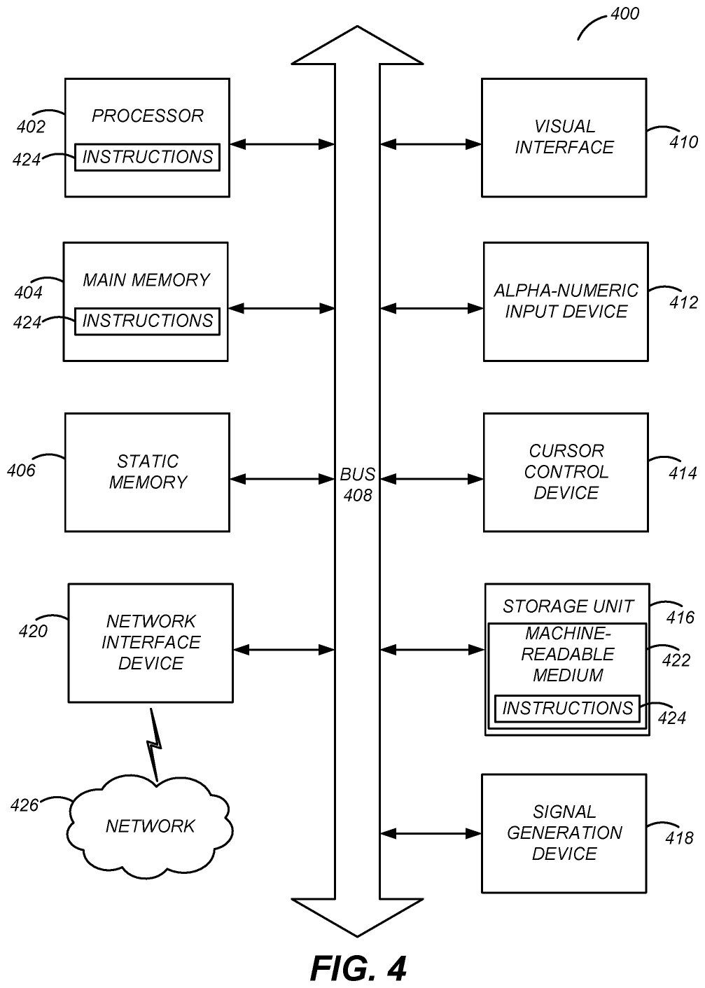

FIG. 4 is a block diagram illustrating components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Processes for Outputting Recommendations

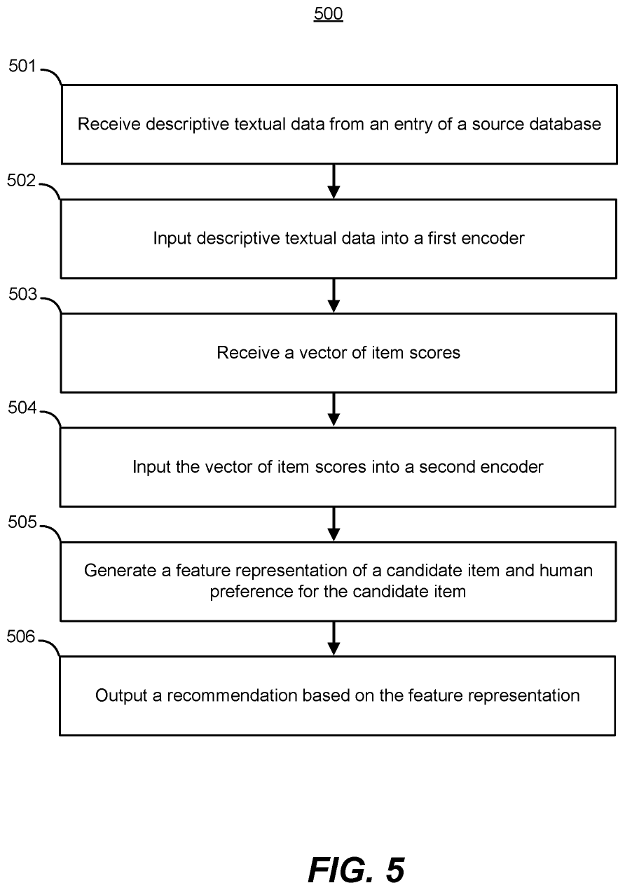

FIG. 5 is a flowchart illustrating process 500 for outputting a recommendation using the inventory catalog management system of FIG. 1.

Inventory catalog management system 140 receives 501 descriptive textual data from an entry of a source database. For example, representation generator 200 of inventory catalog management system 140 receives “chicken sld” from an entry of source database 121 of enterprise 120.

Inventory catalog management system 140 inputs 502 the descriptive textual data into a first encoder. For example, text encoder 201 of representation generator 200 may receive the descriptive textual data as an input. In turn, text encoder 201 may analyze the descriptive textual data to generate a vector of item scores. For example, text encoder 201 analyzes “chicken sld” and determines at least one degree to which the descriptive textual data corresponds to a given candidate item (e.g., at least one value of the vector of item scores). Text encoder 201 may make this determination using Equation 1, described above, that allows encoder 201 to calculate a log likelihood that a word in the product description belongs to a given candidate item. For example, text encoder 201 determines an item score vector of [0.39, 0.75, −0.31, 0.13, 0.03] based on the received descriptive textual data “chicken sld.” This example of an item score vector may correspond to a unique vector representing the inventory item “chicken salad.”

Inventory catalog management system 140 receives 503 a vector of item scores. For example, inventory catalog management system 140 receives the vector of item scores generated by text encoder 201.

Inventory catalog management system 140 inputs 504 the vector of item scores into a second encoder. For example, inventory catalog management system 140 inputs the vector of item scores into affinity encoder 202 of representation generator 200.

Inventory catalog management system 505 generates a feature representation of a candidate item and human preference for the candidate item. For example, affinity encoder 202 receives human characteristic data from enterprises 120 and 130 and/or client devices 150 to determine, for each value of the received vector of item scores, a vector representative of the affinity between each human preference in the human characteristic data (e.g., “is_vegetarian” and “elder”) and the value of the received vector of item scores (e.g., “protein” and “drink”). Although not depicted in FIG. 5, the feature representation may be optimized by optimizer 203 against an optimization target to minimize errors in predicted affinities generated by inventory catalog management system 140 and empirical affinities received by inventory catalog management system 140 (e.g., from enterprises 120 and 130). The feature representation generated may indicate that a vegetarian will have a low affinity for chicken salad, among other predicted affinities.

Inventory catalog management system 140 outputs 506 a recommendation based on the feature representation. For example, product affinity recommender 250 may generate a recommendation based on the feature representation for “chicken salad” and human characteristic data (e.g., user profile data indicating that the customer is a vegetarian). Product affinity recommender 250 may take the dot product of an inventory representation, generated by inventory catalog management system 140 to include the “chicken salad” feature representation, and a customer representation corresponding to the vegetarian customer to determine that the customer has a quantifiably low affinity for “chicken salad,” but a high affinity for “beet salad.”

### ADDITIONAL CONFIGURATION CONSIDERATIONS

Example benefits and advantages of the disclosed configurations include textual encoding to generate product recommendations from highly-variable product descriptions. The inventory catalog management system described herein receives product description data and human characteristic data and generates, using the received data, feature representations that account for both the product and customer affinities to the product.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for encoding textual data for personalized recommendations through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for encoding descriptive textual data, the method comprising:
receiving, over a network, descriptive textual data from an entry of a source database;
inputting the descriptive textual data into a first encoder, the first encoder trained to output, based on the descriptive textual data, a vector of item scores, each value of the vector of item scores being representative of a degree that the descriptive textual data corresponds to a given one of a plurality of candidate items;
receiving, as output from the first encoder, the vector of item scores;
inputting the vector of item scores into a second encoder, the second encoder trained to output, for each value of the vector of item scores, a vector of human characteristic scores, each value of the vector of human characteristic scores being representative of a degree that the candidate item corresponding to the value of the vector of item scores corresponds to a human characteristic;
generating a feature representation of a candidate item of the plurality of candidate items and human preferences for the candidate item; and
outputting, over the network to a client device, a recommendation based on the feature representation.

2. The method of claim 1, further comprising, generating a plurality of feature representations for each respective candidate item of the plurality of candidate items and human preferences for the respective candidate item.

3. The method of claim 1, further comprising:
for a first value of the vector of item scores, determining a first vector of human characteristic scores; and
for a second value of the vector of item scores, determining a second vector of human characteristic scores.

4. The method of claim 3, wherein generating the feature representation comprises concatenating the first vector of human characteristic scores with the second vector of human characteristic scores.

5. The method of claim 3, wherein each value of the vector of item scores represents a respective feature category of a plurality of feature categories.

6. The method of claim 5, wherein determining the first vector of human characteristic scores comprises:
retrieving, from a database of importance measures, a first importance measure corresponding to the feature category, wherein the first importance measure comprises a first weight for a first human preference corresponding to the feature category;
assigning the first importance measure to a first value of the first vector of human characteristic scores;
retrieving, from the database of importance measures, a second importance measure corresponding to the feature category, wherein the second importance measure comprises a second weight for a second human preference corresponding to the feature category; and
assigning the second importance measure to a second value of the first vector of human characteristic scores.

7. The method of claim 1, further comprising:
determining, based on the feature representation and the vector of item scores, an inventory representation;
determining, based on the feature representation, a customer representation;
calculating a dot product of the inventory representation and the customer representation;
determining, based on the dot product, a predicted affinity score;
determining, based on historical inventory order data, an observed affinity score; and
minimizing a mean square error between the predicted affinity score and an observed affinity score;
updating, based on minimizing the mean square error, at least one of the inventory representation or the customer representation; and
storing, in a remote server, the inventory representation and the customer representation.

8. The method of claim 1, wherein the candidate item is a first candidate item, further comprising:
determining that a predicted affinity for the first candidate item is within a range of a predicted affinity for a second candidate item; and
determining that the recommendation comprises recommendations for both the first candidate item and the second candidate item.

9. The method of claim 1, wherein the descriptive textual data is a first set of descriptive textual data and the source database is a first source database, further comprising:
receiving, over the network, a second set of descriptive textual data from an entry of a second source database; and
determining that the first set of descriptive textual data and the second set of descriptive textual data refer to a single candidate item.

10. The method of claim 9, wherein the feature representation is a first feature representation, and wherein determining that the first set of descriptive textual data and the second set of descriptive textual data refer to the single candidate item comprises:
calculating a cosine similarity of the first feature representation and a second feature representation; and
determining, based on the cosine similarity, a similarity value indicative of a degree of similarity between a first item associated with the first set of descriptive textual data and a second item associated with the second set of descriptive textual data.

11. The method of claim 1, wherein each entry of the source database corresponds to an inventory item.

12. The method of claim 11, further comprising:
determining a feature representation for an inventory category; and
comparing each feature representation of a plurality of feature representations to the feature representation for the inventory category, wherein each of the plurality of feature representations correspond to a respective plurality of items in the list of inventory.

13. The method of claim 12, further comprising categorizing, based on the comparisons, a set of the plurality of items as belonging to the inventory category.

14. The method of claim 12, further comprising ranking, based on the comparisons, a set of the plurality of items as having a respective plurality of similarity values within a range of a similarity value of a target item in the inventory category.

15. A system for encoding descriptive textual data, the system comprising:
a text encoder configured to:
receive, over a network, descriptive textual data from an entry of a source database; and
determine, based on the descriptive textual data, a vector of item scores, each value of the vector of item scores being representative of a degree that the descriptive textual data corresponds to a given one of a plurality of candidate items;
an affinity encoder configured to:
receive, as output from the text encoder, the vector of item scores;
determine, for each value of the vector of item scores, a vector of human characteristic scores, each value of the vector of human characteristic scores being representative of a degree that the candidate item corresponding to the value of the vector of item scores corresponds to a human characteristic; and
generate a feature representation of a candidate item of the plurality of candidate items and human preferences for the candidate item; and
a product recommender configured to output, over the network to a client device, a recommendation based on the feature representation.

16. The system of claim 15, wherein the descriptive textual data is a first set of descriptive textual data and the source database is a first source database, further comprising:
receiving, over the network, a second set of descriptive textual data from an entry of a second source database; and
determining that the first set of descriptive textual data and the second set of descriptive textual data refer to a single candidate item.

17. The system of claim 16, wherein the feature representation is a first feature representation, and wherein determining that the first set of descriptive textual data and the second set of descriptive textual data refer to the single candidate item comprises:
calculating a cosine similarity of the first feature representation and a second feature representation; and
determining, based on the cosine similarity, a similarity value indicative of a degree of similarity between a first item associated with the first set of descriptive textual data and a second item associated with the second set of descriptive textual data.

18. A non-transitory computer readable storage medium storing executable instructions that, when executed by one or more processors, cause the one or more processors to perform operations comprising:
receiving, over a network, descriptive textual data from an entry of a source database;
inputting the descriptive textual data into a first encoder, the first encoder trained to output, based on the descriptive textual data, a vector of item scores, each value of the vector of item scores being representative of a degree that the descriptive textual data corresponds to a given one of a plurality of candidate items;
receiving, as output from the first encoder, the vector of item scores;
inputting the vector of item scores into a second encoder, the second encoder trained to output, for each value of the vector of item scores, a vector of human characteristic scores, each value of the vector of human characteristic scores being representative of a degree that the candidate item corresponding to the value of the vector of item scores corresponds to a human characteristic;
generating a feature representation of a candidate item of the plurality of candidate items and human preferences for the candidate item; and
outputting, over the network to a client device, a recommendation based on the feature representation.

19. The non-transitory computer readable storage medium of claim 18, wherein the descriptive textual data is a first set of descriptive textual data and the source database is a first source database, further storing executable instructions that, when executed by one or more processors, cause the one or more processors to perform steps comprising:
receiving, over the network, a second set of descriptive textual data from an entry of a second source database; and
determining that the first set of descriptive textual data and the second set of descriptive textual data refer to a single candidate item.

20. The non-transitory computer readable storage medium of claim 19, wherein the feature representation is a first feature representation, and wherein determining that the first set of descriptive textual data and the second set of descriptive textual data refer to the single candidate item comprises:
calculating a cosine similarity of the first feature representation and a second feature representation; and
determining, based on the cosine similarity, a similarity value indicative of a degree of similarity between a first item associated with the first set of descriptive textual data and a second item associated with the second set of descriptive textual data.
